(19) United States
(12) Patent Application Publication
(10) Pub. No.: US 2007/0005631 A1
(43) Pub. Date: Jan. 4, 2007

(54) Apparatus and method for dynamically determining index split options from monitored database activity

(75) Inventors: Eric Lawrence Barsness, Pine Island, MN (US); Daniel E. Beuch, Rochester, MN (US); John Matthew Santosuosso, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/171,728

(22) Filed: Jun. 30, 2005

(51) Int. Cl. G06F 7/00

(52) U.S. Cl. 707/102

(57) ABSTRACT

The activity of a database is monitored, and index split options are dynamically determined from the monitored database activity. Appropriate action may then be taken based on the dynamically determined index split options. For example, the index may be automatically split using the dynamically determined index split options. A user command that specifies index split options may be compared to the dynamically determined index split options, and if the user command is not compatible with the dynamically determined index split options, the command may be inhibited, or the user may receive a warning message in response to the command. In addition, existing index use may be monitored, and if the monitored index use indicates the index is split poorly, the index may be re-generated using the dynamically determined index split options.

### BACKGROUND OF THE INVENTION

1. Technical Field

This invention generally relates to computer systems, and more specifically relates to database apparatus and methods.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records are returned as the query result. Structured Query Language (SQL) is one specific query language that may be used to query a database.

Indexes are often created to speed up the process of querying the database. An index is generally created over one or more columns in a database table. Key values in the index may then be used to more quickly locate rows in the table that satisfy the query. When database tables become large, their corresponding indexes also become large. When an index becomes too large to fit on one page, it may be split to fit on two pages. There are known ways to split index pages using options for a CREATE INDEX command that govern how the index page is split when it becomes too large to fit on a page. However, the usage of the known options depends upon a human database administrator guessing at the time the index is created how the index pages should be split in the future. Without a way to automatically detect how an index is being used and assure that index page splits are done in a way best suited to the monitored use, the database industry will continue to suffer from index pages that are split in inefficient ways.

### DISCLOSURE OF INVENTION

According to the preferred embodiments, the activity of a database is monitored, and index split options are dynamically determined from the monitored database activity. Appropriate action may then be taken based on the dynamically determined index split options. For example, the index may be automatically split using the dynamically determined index split options. A user command that specifies index split options may be compared to the dynamically determined index split options, and if the user command is not compatible with the dynamically determined index split options, the command may be inhibited, or the user may receive a warning message in response to the command. In addition, existing index use may be monitored, and if the monitored index use indicates the index is split poorly, the index may be re-generated using the dynamically determined index split options.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a sample index with a corresponding CREATE INDEX command showing how the existing index may be split in the prior art using a SPLIT PAGE SYMMETRIC option;

FIG. 3 is a sample index with a corresponding CREATE INDEX command showing how the existing index may be split in the prior art using a SPLIT PAGE HIGH option;

FIG. 4 is a sample index with a corresponding CREATE INDEX command showing how the existing index may be split in the prior art using a SPLIT PAGE LOW option;

FIG. 5 is a flow diagram of a method in accordance with the preferred embodiments for dynamically determining index split options from monitored database activity;

FIG. 6 is a flow diagram of a potential action that may be performed in step 530 in FIG. 5 in accordance with the preferred embodiments;

FIG. 7 is a flow diagram of potential actions that may be performed in step 530 in FIG. 5 in accordance with the preferred embodiments; and

FIG. 8 is a flow diagram of potential actions that may be performed in step 530 in FIG. 5 in accordance with the preferred embodiments.

### BEST MODE FOR CARRYING OUT THE INVENTION

1.0 Overview

The present invention relates to the splitting of index pages in a database. For those not familiar with indexes or index page splitting, this Overview section will provide background information that will help to understand the present invention.

### Known Indexes and Index Page Splitting

Indexes are commonly used in databases to speed the retrieval of data from the database. Version 8.1 of DB2 database includes the ability to control the splitting of index pages when they become full. Index split options allow a user to specify how an index page is split when it becomes full. These index split options are typically specified as parameters to a CREATE INDEX command. By specifying the index split operations when the index is created, index pages may be split as needed in the future based on the index split options specified in the CREATE INDEX command. Examples are shown herein that illustrate the desirability of intelligently splitting index pages.

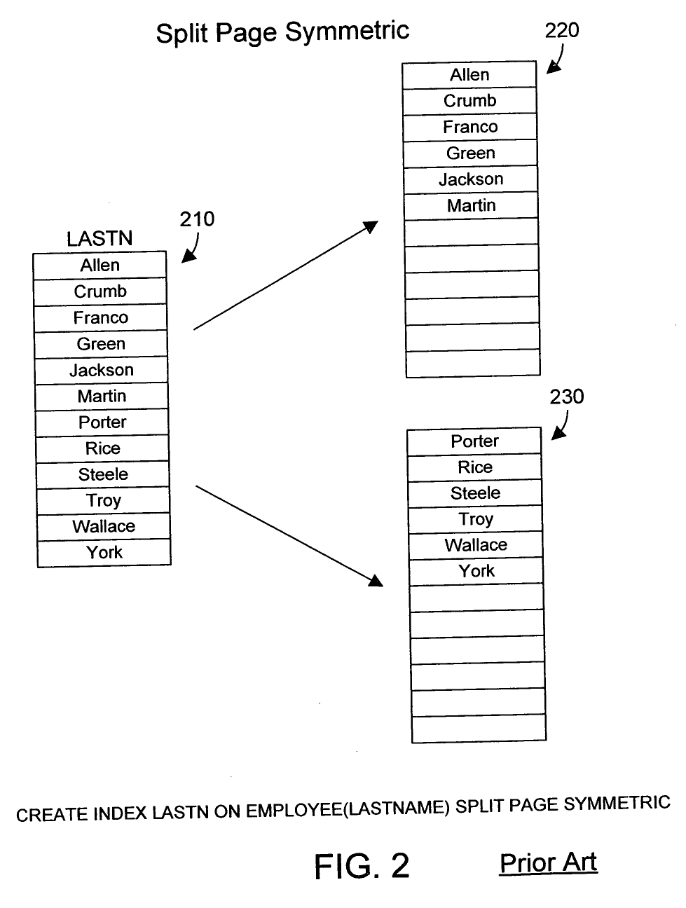

Referring to FIG. 2, a CREATE INDEX command at the bottom of the page creates an index LASTN over the LASTNAME column of an EMPLOYEE table. The SPLIT PAGE SYMMETRIC in the command constitutes an index split option that specifies that when an index page becomes full, it may be split symmetrically into two pages. In the example of FIG. 2, the index is alphabetical over the employee's last name. Because future inserts in the index are just as likely to be in the first half of the alphabet as in the last half, the SPLIT PAGE SYMMETRIC is an appropriate index split option for the system administrator to specify in the CREATE INDEX command that creates the index. When the index page 210 in FIG. 2 gets full, the index page 210 may be split into two pages 220 and 230 that each contain approximately half of the data, as shown in FIG. 2. In this manner, future inserts will likely occur into both pages at approximately the same rate, thereby creating an efficient split of the index page.

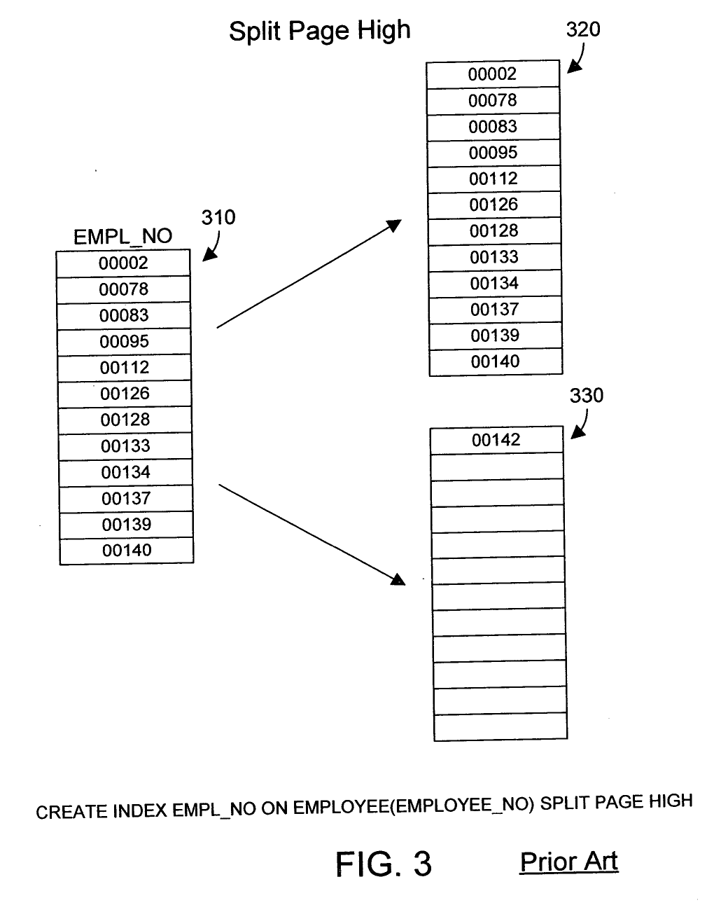

Sometimes a symmetrical split as shown in FIG. 2 produces undesirable results. For example, let's assume the EMPLOYEE table referenced in FIG. 2 includes an EMPLOYEE_NO column that specifies an employee number for the employee. Let's further assume for this example that an employee number is a five digit number that is sequentially assigned as each employee is hired. This means that the employee number of each new employee will be larger than the employee number of other employees. If the index page 310 in FIG. 3 were split symmetrically, as shown in FIG. 2, the top page would remain half empty, because all future inserts would have values higher than all of the previous values. Leaving an index page half empty would be an inefficient use of the index page. For this reason, a SPLIT PAGE HIGH index split option may be specified that directs all existing index entries to be placed in one page 320, while all new insertions are performed in an empty page 330. Thus, the next entry 00142 is inserted into table 330 as shown in FIG. 3. Because we know for a fact that the employee number of all new employees will be greater than the employee number of existing employees, the SPLIT PAGE HIGH option shown in FIG. 3 produces a much more efficient use of index space.

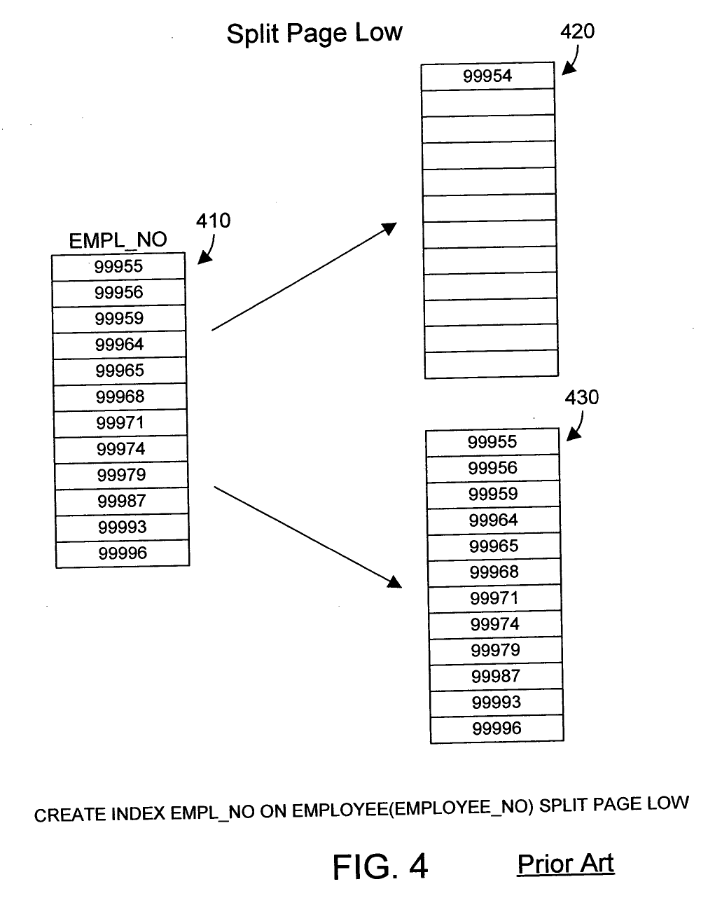

There may be circumstances when all new index entries will be less than the existing entries. In this case, a SPLIT PAGE LOW option may be specified, as shown in FIG. 4. In this case, we assume the value for the employee number started at a high value, and is decremented one and assigned as each employee is hired. This means that each new hire will have an employee number that is less than all previously-assigned employee numbers. For this reason, the SPLIT PAGE LOW option works well to split page 410, creating a full page 430 of the existing values, along with an empty page 420 into which all future inserts will be made, because their values are less than those in the other page. Thus, the next entry 99954 is inserted into table 420 as shown in FIG. 4.

The examples in FIGS. 2-4 are shown to illustrate known index split options. Other than SPLIT PAGE SYMMETRIC, SPLIT PAGE HIGH, and SPLIT PAGE LOW, other known index split options include: PCTFREE, LEVEL2 PCTFREE, MINPCTUSED, CLUSTER, and ALLOW REVERSE SCANS. Note that FIGS. 2-4 include CREATE INDEX commands with specified index split options that are known in the art to split the index pages as shown. However, these prior art commands require the system administrator to explicitly specify the index split options when an index is created.

### 2.0 DESCRIPTION OF THE PREFERRED EMBODIMENTS

The preferred embodiments recognize that a system administrator's specification of index split options at the time an index is created may be inefficient for future page splits. Furthermore, relying upon a system administrator to manually specify the appropriate index split option introduces potential human error that may negatively impact index performance. Instead of manually specifying index split options, the preferred embodiments monitor database activity, then dynamically determine appropriate index split options. The dynamically determined index split options may then be used to determine one or more appropriate actions.

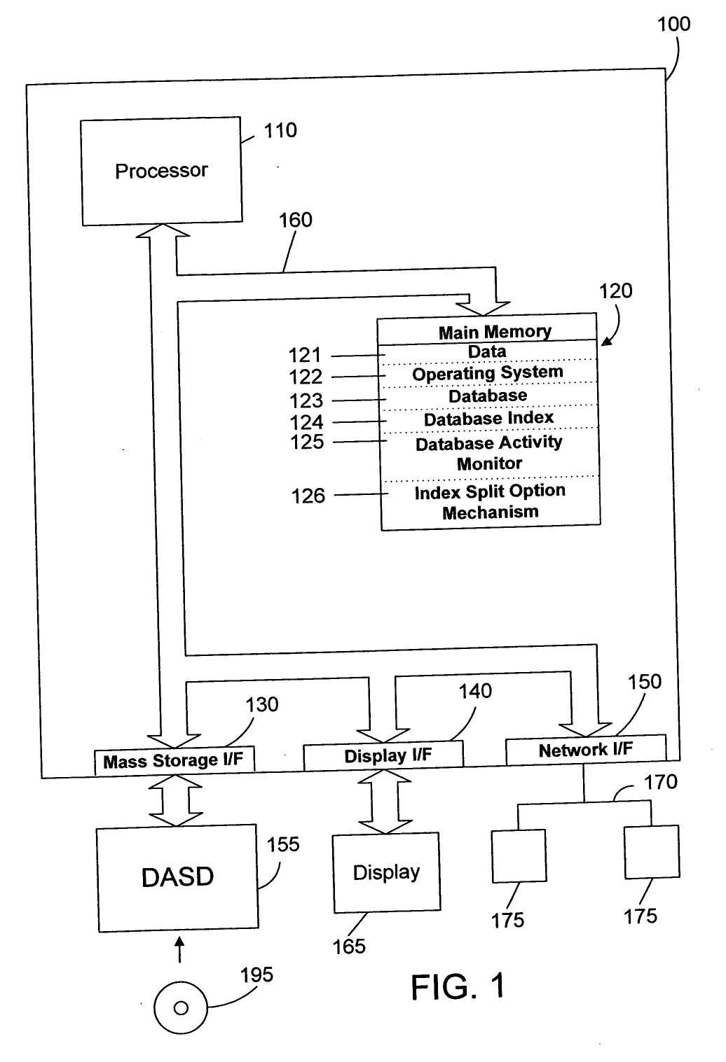

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a database 123, one or more database indexes 124, a database activity monitor 125, and an index split option mechanism 126. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Database 123 is any suitable database, whether currently known or developed in the future. Database 123 preferably includes one or more tables. Database index 124 is an index built over one or more columns in a table residing in the database 123. Database activity monitor 125 monitors database activity, especially inserts into an index 124. The database activity monitor 125 may be implemented in a number of different ways within the scope of the preferred embodiments. For example, the database activity monitor 125 could reside in the database engine itself. In the alternative, the database activity monitor 125 could determine database activity from a journal for the database and from the database metadata. The database activity monitor 125 could also be a standard database monitor tool. In the alternative, the database activity monitor 125 could receive the monitored database activity from the database engine, from the journal and metadata, or from a separate database monitor tool. The preferred embodiments expressly extend to any and all implementations of a database activity monitor that is capable of monitoring a database index or receiving monitored data for a database index.

Index split option mechanism 126 reviews the database activity monitored by the database activity monitor 125, then determines appropriate index split options for an index based on the monitored activity. By dynamically determining index split options from monitored database activity, the index split options are more likely to produce index pages that enhance index performance after the index page is split.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, database index 124, database activity monitor 125, and index split option mechanism 126 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

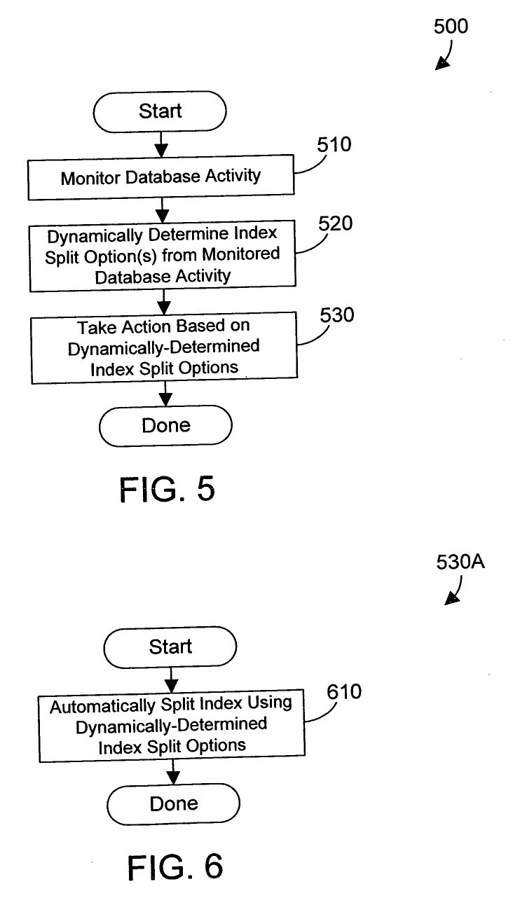

Referring now to FIG. 5, a method 500 in accordance with the preferred embodiments begins by monitoring database activity (step 510). The database activity of most interest is the value of inserts into an index. As described above, the monitoring of the database activity may be performed by the database engine, by analyzing a journal and metadata for the database, or by reviewing data from a database monitor tool. Next, index split options are dynamically determined from the monitored database activity (step 520). One or more actions may then be taken based on the dynamically determined index split options (step 530). In this manner, method 500 performs actions based on dynamically determined index split options that are based on monitored database activity.

One suitable action in step 530 of FIG. 5 is shown as method 530A in FIG. 6. The index may be automatically split using the dynamically determined index split options (step 610). In this manner, the monitoring of inserts into an index may directly drive how a page in the index is split. For example, the monitoring of inserts into the index of FIG. 2 would recognize that the values of inserts into the index are random, driven by the alphabetical order of the employee's last name. In this case, the SPLIT PAGE SYMMETRIC index split option could be automatically specified for the index, which will cause the index to be split symmetrically as shown in FIG. 2, without the user or system administrator having to explicitly specify the split option. In other words, we assume the dynamically determined index split option may be added to an index even though the statement that created the index did not specify this split option. In the alternative, if the statement that created the index specified a split option that is different than the dynamically determined split option, the dynamically determined split option may override the user-specified split option to provide better performance of the index according to the monitored activity.

If the activity of the index in FIG. 3 is monitored, it will be seen that each insert has a value that is greater than previous inserts. In this example, the SPLIT PAGE HIGH option can be dynamically determined to be the best index split option, causing the index page to be split as shown in FIG. 3 without the need for the user to explicitly specify the SPLIT PAGE HIGH option. Similarly, if the activity in the index in FIG. 4 is monitored, it will be seen that each insert has a value that is less than the previous inserts. In this example, the SPLIT PAGE LOW option can be dynamically determined to be the best index split option, causing the page to be split as shown in FIG. 3 without the need for the user to explicitly specify the SPLIT PAGE LOW option.

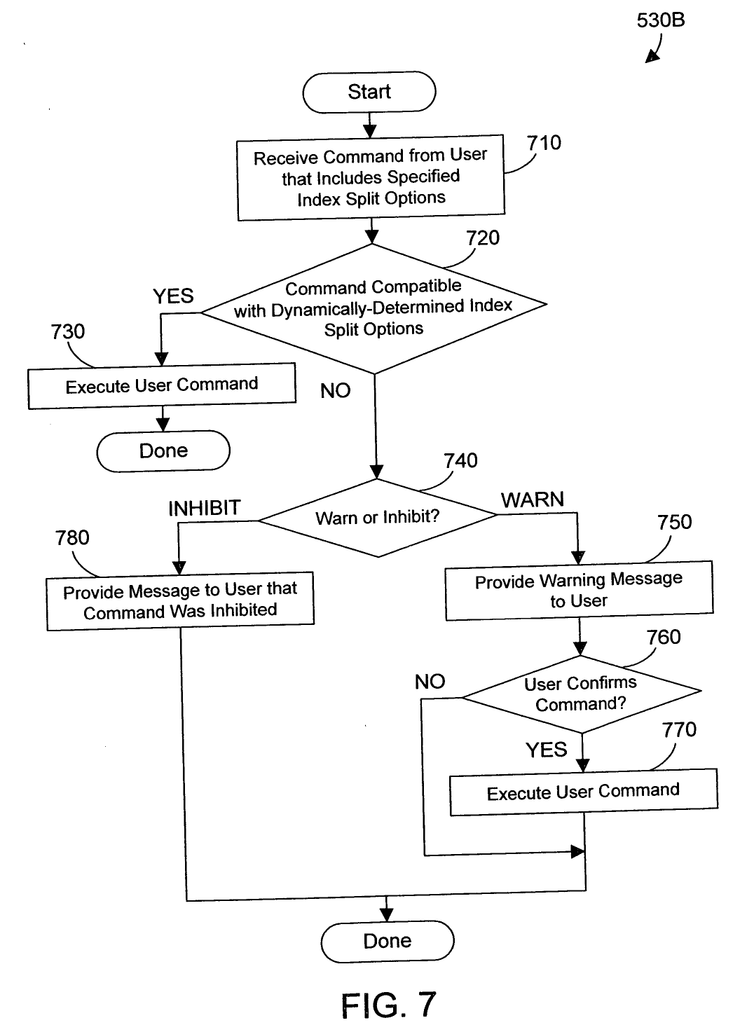

Another suitable action in step 530 of FIG. 5 is shown as method 530B in FIG. 7. A user command is received that specifies index split options (step 710). If the command is compatible with the dynamically determined index split options (step 720=YES), the user command is executed (step 730). If, however, the command is not compatible with the dynamically determined index split options (step 720=NO), the action depends on whether the system has been programmed to warn the user of a potentially bad split command, or to inhibit the potentially bad split command. If the system is programmed to warn the user (step 740=WARN), a warning message is provided to the user (step 750). If the user confirms the desire to execute the command notwithstanding the warning (step 760=YES), the user command is executed (step 770). If the user does not confirm the command (step 760=NO), the command is not executed. If the system is programmed to inhibit a command that is not compatible with the dynamically determined index split options (step 740=INHIBIT), a message is provided to the user that the command was inhibited (i.e., not executed) (step 780). Method 530B provides a way to warn a user or inhibit a user command that would create a poor split based on the monitored index activity.

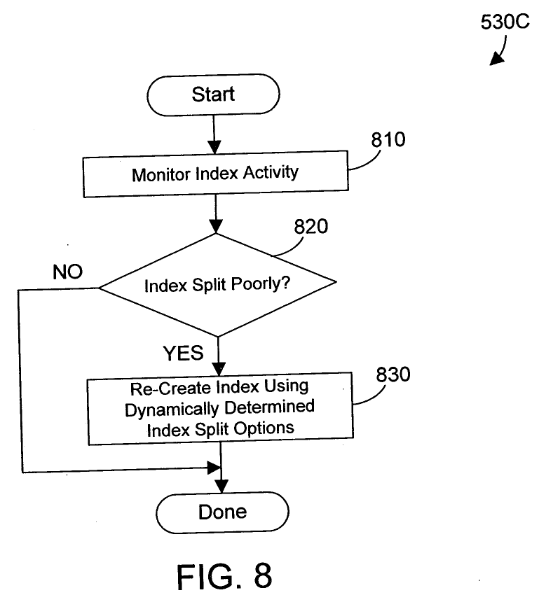

Yet another suitable action in step 530 of FIG. 5 is shown as method 530C in FIG. 8. The activity on an index is monitored (step 810). If the index is split poorly (step 820=YES), the index may be re-created using the dynamically determined index split options (step 830) to provide a more optimal index. If the index is not split poorly (step 820=NO), method 530C is done.

Note that the dynamically determined index split options may change over time as needed. For example, let's assume a company starts assigning employee number at 99,999, and decrements the employee number by one for each employee that is hired. This is the example shown in FIG. 4. The dynamically determined index split option based on the insert activity of the index is SPLIT PAGE LOW as shown in FIG. 4. Now let's suppose that the company hires its 100,000^{th} employee. Because the decrementing employee numbers have been exhausted, we assume the employee number is then changed to an incrementing employee number starting at 100,000. The insert activity on the index is monitored, and it is discovered that all inserts now have values greater than existing index entries. As a result, the index split option may be dynamically changed from SPLIT PAGE LOW to SPLIT PAGE HIGH to accommodate the changed insert activity on the index. This simple example shows how index split options may be dynamically changed and tuned according to the monitored insert activity on the index.

The preferred embodiments allow dynamically determining appropriate index split options according to monitored database activity. By tuning the splitting of an index according to the monitored activity of the index, the preferred embodiments greatly enhance the efficiency of index pages when they are split.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a database residing in the memory;
an index residing in the memory for a table in the database;
a database activity monitor that monitors activity in the database; and
an index split option mechanism that receives information from the database activity monitor regarding activity in the index, and that dynamically determines from the information at least one index split option for the index.

2. The apparatus of claim 1 wherein the index split option mechanism performs at least one action based on the dynamically determined at least one index split option.

3. The apparatus of claim 2 wherein the at least one action comprises automatically splitting a page in the index using the dynamically determined at least one index split option.

4. The apparatus of claim 2 wherein the at least one action comprises:
receiving a user command that includes a user-specified index split option; and
determining whether the user-specified index split option is compatible with the dynamically determined at least one index split option.

5. The apparatus of claim 4 wherein the at least one action comprises warning the user if the user-specified index split option is not compatible with the dynamically determined at least one index split option.

6. The apparatus of claim 4 wherein the at least one action comprises inhibiting execution of the user command if the user-specified index split option is not compatible with the dynamically determined at least one index split option.

7. The apparatus of claim 2 wherein the at least one action comprises determining from the database activity monitor whether the index is split poorly, and if so, dynamically re-creating the index using the dynamically determined at least one index split option.

8. A computer-implemented method for splitting an index for a table in a database, the method comprising the steps of:
monitoring activity in the database; and
dynamically determining from the monitored database activity at least one index split option for splitting the index.

9. The method of claim 8 further comprising the step of performing at least one action based on the dynamically determined at least one index split option.

10. The method of claim 9 wherein the at least one action comprises automatically splitting a page in the index using the dynamically determined at least one index split option.

11. The method of claim 9 wherein the at least one action comprises:
receiving a user command that includes a user-specified index split option; and
determining whether the user-specified index split option is compatible with the dynamically determined at least one index split option.

12. The method of claim 11 wherein the at least one action comprises warning the user if the user-specified index split option is not compatible with the dynamically determined at least one index split option.

13. The method of claim 1 1 wherein the at least one action comprises inhibiting execution of the user command if the user-specified index split option is not compatible with the dynamically determined at least one index split option.

14. The method of claim 9 wherein the at least one action comprises determining from the database activity monitor whether the index is split poorly, and if so, dynamically re-creating the index using the dynamically determined at least one index split option.

15. A program product comprising:
(A) an index split option mechanism that receives information from a database activity monitor regarding activity in an index, and that dynamically determines from the information at least one index split option for the index; and
(B) computer-readable signal bearing media bearing the index split option mechanism.

16. The program product of claim 15 wherein the computer-readable signal bearing media comprises recordable media.

17. The program product of claim 15 wherein the computer-readable signal bearing media comprises transmission media.

18. The program product of claim 15 wherein the index split option mechanism performs at least one action based on the dynamically determined at least one index split option.

19. The program product of claim 15 wherein the at least one action comprises automatically splitting a page in the index using the dynamically determined at least one index split option.

20. The program product of claim 15 wherein the at least one action comprises:
receiving a user command that includes a user-specified index split option; and
determining whether the user-specified index split option is compatible with the dynamically determined at least one index split option.

21. The program product of claim 20 wherein the at least one action comprises warning the user if the user-specified index split option is not compatible with the dynamically determined at least one index split option.

22. The program product of claim 20 wherein the at least one action comprises inhibiting execution of the user command if the user-specified index split option is not compatible with the dynamically determined at least one index split option.

23. The program product of claim 15 wherein the at least one action comprises determining from the database activity monitor whether the index is split poorly, and if so, dynamically re-creating the index using the dynamically determined at least one index split option.
